(19) United States
(12) Patent Application Publication
(10) Pub. No.: US 2026/0285113 A1
(43) Pub. Date: Sep. 24, 2026

(54) RESOURCE-SAVING CHASSIS CONTROL FOR, IN PARTICULAR ACTIVE, CHASSIS

(71) Applicant: AUDI AG, Ingolstadt (DE)

(72) Inventor: Andreas UNGER, Gaimersheim (DE)

(73) Assignee: AUDI AG, Ingolstadt (DE)

(21) Appl. No.: 19/439,770

(22) Filed: Jan. 5, 2026

(30) Foreign Application Priority Data
Mar. 21, 2025 (DE) 102025111054.9

(51) Int. Cl. B60G 17/018

(52) U.S. Cl. CPC B60G 17/018; B60G 2400/91; B60G 2600/182

(57) ABSTRACT

Chassis control of a chassis, including a first computing unit and a second computing unit arranged spaced apart from one another. The first computing unit is configured to determine wheel data describing wheel dynamics of a wheel; and the second computing unit is configured to determine vehicle body data describing the body dynamics of a vehicle body. The first computing unit and the second computing unit are connected for data exchange. The first computing unit is configured to arbitrate the wheel data and the vehicle body data, and the chassis control is configured to determine a desired force for an actuator of the chassis control.

### FIELD

The present invention relates to a chassis control and a method for the operation thereof.

### BACKGROUND

Computing units for solving a control task for controlling the rolling stiffness of a vehicle, the data of which converge in a “control apparatus”, are known from US 2006/0006615 A1. This control apparatus then controls stabilizers. This can result in performance problems.

### SUMMARY

It is therefore an object of the present invention to improve and/or simplify a chassis, in particular its control, preferably to reduce one or more of the above-mentioned disadvantages, preferably to avoid them.

According to one embodiment of the present invention, a chassis control is provided. In one embodiment, the chassis control comprises a first computing unit and a second computing unit, wherein the computing units are connected in data exchange or in a data-exchanging manner, in particular with the aid of a data connection, in particular a bus. In one embodiment, the first computing unit and the second computing unit are arranged spaced apart from one another, in particular physically separated, in particular such that the first computing unit, in one embodiment, is arranged in and/or on a wheel, in particular in and/or on a wheel suspension of the wheel, furthermore in particular such that the first computing unit processes data from a sensor of the wheel or a sensor which is configured to detect parameters or parameter values of the wheel, in particular of an actuator of the chassis, in particular at the wheel. In one embodiment, the first computing unit is configured to determine wheel data, wherein the wheel data, in particular at least, describe wheel dynamics of a wheel. In one embodiment, the second computing unit is configured to determine vehicle body data, wherein the vehicle body data, in particular at least, describe vehicle body dynamics of a vehicle body. In one embodiment, the first computing unit is configured to arbitrate the wheel data and the vehicle body data. In one embodiment, the first computing unit is configured as arbiter to process the wheel data and the vehicle body data. In one embodiment, the chassis control is configured to determine a desired force for an actuator of the chassis control.

The term “computing unit” as used herein is preferably to be understood as an independent computing unit and/or a computing unit integrated in a control unit. In one embodiment, a control unit comprises a computing unit, in particular a first control unit comprises a first computing unit and a second control unit comprises a second computing unit.

In one embodiment, a data connection or a data bus can advantageously be saved in this way, in particular a data bus having low(er) data bandwidth can be used for the chassis control. Furthermore, in one embodiment, an EM compatibility of the chassis control can be increased in this way, in particular by saving data connections. Furthermore, in one embodiment, this makes it possible for the second computing unit, in particular a control unit that comprises the second computing unit, to have less computing power or to use (this, in particular saved,) computing power for other tasks. Furthermore, in one embodiment, this can reduce the amount of data that has to be sent via the data bus. In one embodiment, this can result in cost savings or, in one embodiment, the system costs are reduced in this way.

In one embodiment, the first computing unit is configured to process signals with a cycle time that is in the range of the natural frequency of the wheel or the wheel dynamics, in particular a cycle time that is configured to process signals with at least 10 Hz, or with at least 14 Hz, or with at least 15 Hz and/or with at most 25 Hz, or with at most 20 Hz, or with at most 15 Hz.

Advantageously, this makes it possible, in one embodiment, to correctly and/or more precisely calculate or determine an actuator force, in particular a signal that describes the actuator force. Furthermore, in one embodiment, this allows the communication resources of the chassis control or the vehicle to be used (more) efficiently, in particular to be designed (more) simply or to save costs.

In one embodiment, the first computing unit is configured to determine, in particular to process, wheel data, in particular describing wheel dynamics, with a cycle time of 1 millisecond or faster, and furthermore, in particular, to determine an actuator force, in particular a desired actuator force, based on the determined wheel data.

Advantageously, in one embodiment, this allows calculations relating to the wheel dynamics to be carried out, at least essentially, in real time, in particular to be supplemented more easily by lower-frequency signals relating to the dynamics of the vehicle structure, especially by signals or results (vehicle structure data) from the second computing unit.

In one embodiment, the second computing unit is configured to determine, in particular to process, vehicle body data with a cycle time of greater than 4 ms, or greater than 5 ms and/or less than 1 second, or less than 100 ms and furthermore, in particular, to determine an actuator force, in particular a desired actuator force, based on the determined vehicle body data.

Advantageously, in one embodiment, this makes it possible for the second computing unit, which in one embodiment is or can be hierarchically positioned above the first computing unit, to be (more) cost-effective, in particular because the computing power of the second computing unit can be or is less than that of comparable computing units of the prior art due to the chassis control described herein.

In one embodiment, the first computing unit comprises an FPGA, a GPU, an ASIC, and/or a CPU, or the like. In one embodiment, at least part of the first computing unit is designed as an FPGA and/or ASIC. In one embodiment, the first computing unit comprises an actuator control unit or an actuator ECU, or is designed as such.

Advantageously, in one embodiment, a computing power of the first computing unit can be increased or is increased in this way.

In one embodiment, the second computing unit can be referred to as a high-level control unit or ECU.

According to one embodiment of the present invention, a method for operating a chassis control is provided. In one embodiment, the method comprises capturing wheel data using the first computing unit. In one embodiment, the method comprises determining an actuator force, in particular a desired actuator force, or actuator response of the chassis based on the captured wheel data. In one embodiment, the method comprises capturing vehicle body data using the second computing unit. In one embodiment, the method comprises determining an actuator force, in particular a desired actuator force, or actuator response. In one embodiment, the method comprises arbitrating the wheel data and the vehicle body data with the aid of the first computing unit. In one embodiment, the method comprises operating an actuator of the chassis control based on the arbitration.

Advantageously, in one embodiment, this can enable computing requirements of the second computing unit and/or the, in particular required, bandwidth of the data connection to be able to be or to be reduced in particular by the functional allocation onto the first computing unit and the second computing unit.

According to one embodiment of the present invention, a vehicle is provided which comprises a chassis control described herein and/or comprises means for carrying out or performing a method described herein. In one embodiment, the vehicle comprises a first computing unit, which in one embodiment is configured to capture wheel data, and a second computing unit, which in one embodiment is configured to capture vehicle body data. In one embodiment, the vehicle comprises means for determining an actuator response of the chassis based on the captured wheel data. In one embodiment, the vehicle comprises means for determining an actuator response of the chassis based on the captured vehicle body data. In one embodiment, the first computing unit is configured to arbitrate the wheel data and the vehicle body data, in particular the vehicle and/or the first computing unit comprises means for arbitrating the wheel data and the vehicle body data.

Advantageously, embodiment, a (more) optimized functional allocation can be implemented in this way, in particular the efficiency of calculations can be or is increased and/or the data transmission can be or is improved. In one embodiment, the system costs can be reduced, since in particular less powerful and therefore more cost-effective control units or computing units can be used.

The term “arbitration”, as used herein, is to be understood in particular as the switching or superposition of asynchronous signals. In one embodiment, the clock speed of the first computing unit and the second computing unit can be different or, in one embodiment, a functional allocation between the first computing units and the second computing unit can be implemented in this way, which in one embodiment contributes to cost savings and/or reduces or can reduce EMC susceptibility.

A means in the sense of the present invention can be in the form of hardware and/or software, in particular comprising at least one, in particular microprocessor unit (CPU), graphics card (GPU), or the like, and/or one or more programs or program modules, preferably connected with respect to data and/or signals to a storage and/or bus system. The processing unit can be designed to execute commands implemented as a program stored in a memory system, to capture input signals from a data bus, and/or to output signals to a data bus. A storage system can comprise one or more, in particular different, storage media, in particular optical, magnetic, solid-state, and/or other non-volatile media. The program can be designed in such a way that it embodies or is capable of executing the methods described here, so that the processing unit can perform the steps of such procedures and thus in particular can operate or monitor the chassis control.

A computer program product can, in one embodiment, comprise, in particular can be, a storage medium, in particular a computer-readable and/or non-volatile storage medium, for storing a program or instructions, or having a program stored thereon or instructions stored thereon. In one embodiment, the execution of this program or these instructions by a system or a controller, in particular a computer or an arrangement of multiple computers, causes the system or the controller, in particular the computer(s), to carry out a method described herein or one or more of its steps, or the program or instructions are configured for this purpose.

In one embodiment, one or more, in particular all, steps of the method are carried out fully or partially automatically, in particular by the control system or its means.

The term supposedly used herein such as “comprises”, “contains”, “incorporates”, “includes”, “has”, “having”, or any other variant thereof is to cover a nonexclusive incorporation. For example, a method or a device that comprises or includes a list of elements is not necessarily restricted to these elements, but rather can incorporate other elements which are not expressly listed or which are inherent to such a method or such a device.

Furthermore, unless explicitly stated otherwise, “or” refers to an inclusive or and not an exclusive “or”. For example, a condition A or B is met by one of the following conditions: A is true (or present) and B is false (or not present), A is false (or not present) and B is true (or present), and both A and B are true (or present).

The terms “a” or “an”, as used here, are defined in the sense of “one/one or more”. The terms “another” and “a further” as well as any other variant thereof are to be understood in the sense of “at least one more”.

The terms “configured” or “set up” to perform a specific function (and any variations thereof), as possibly used here, are to be understood to mean that a device in this respect or component thereof is already in a design or setting in which it can perform the function, or at least is adjustable —i.e. configurable—so that it can perform the function after appropriate adjustment. The configuration can be carried out here, for example, via a corresponding adjustment of parameters of a process sequence or switches or the like to activate or deactivate functionalities or settings. In particular, the device can have multiple predetermined configurations or operating modes, so that the configuration can be carried out by selecting one of these configurations or operating modes.

### BRIEF DESCRIPTION OF THE FIGURES

Further advantages, features, and possible uses of the present invention result from the following description in conjunction with the figures. In the figures:

FIG. 1 schematically shows a quarter vehicle model having a vehicle body and a wheel according to one embodiment;

FIG. 2 schematically shows a block diagram of an embodiment of a method for operating a chassis control; and

FIG. 3 schematically shows a first computing unit and a second computing unit.

### DETAILED DESCRIPTION

Elements depicted in the figures are not necessarily shown to scale. Rather, the various elements depicted in the figures are rendered in such a way that their function and general purpose become understandable to the person skilled in the art. Connections and couplings between functional units and elements shown in the figures can also be implemented as indirect connections or couplings, unless explicitly stated otherwise. Functional units can be implemented in particular as hardware, software, or a combination of hardware and software.

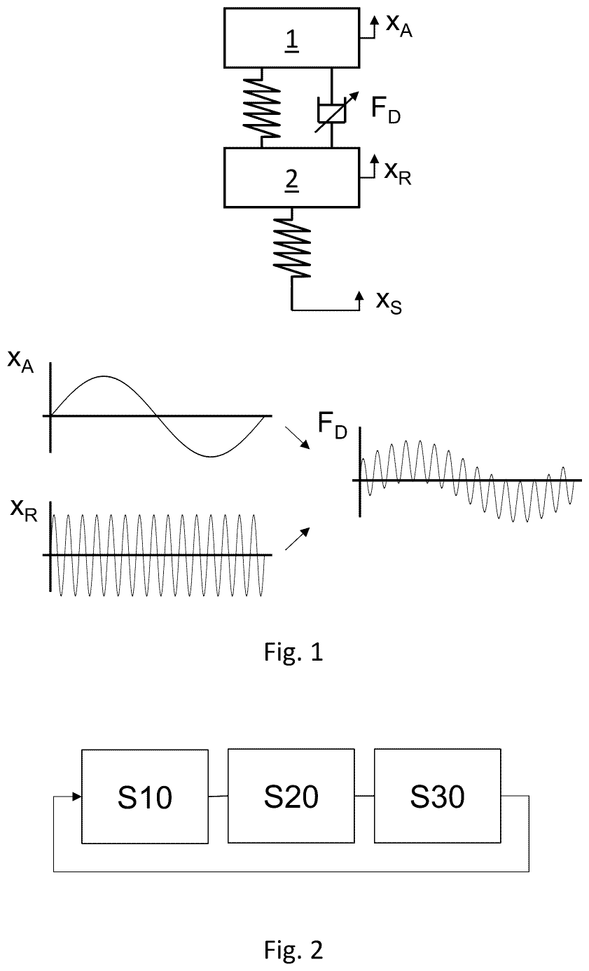

FIG. 1 schematically shows a quarter vehicle model having a vehicle body 1 and a wheel 2. These are connected with the aid of a chassis or a chassis control, in particular an active chassis control. Furthermore, FIG. 1 shows an adjustable, in particular active, chassis control, in particular having an adjustable actuator force F_{D}, in particular a desired actuator force. The dynamics of the vehicle structure are represented by X_{A}, the dynamics of the wheel by x_{R}, and a distance traveled by the wheel by X_{S}. Furthermore, this is shown over time in the graphs below, from which an actuator force is or can be determined via arbitration and/or (in one embodiment) superposition (see arrows and graph for F_{D}).

FIG. 2 schematically represents a block diagram for one embodiment of a method described herein. S10 represents a capture of wheel data and, in one embodiment, a determination of desired actuator data that describe an actuator response. S20 represents a capture of vehicle body data and, in one embodiment, a determination of desired actuator data that describe an actuator response, in particular with respect to the captured vehicle body data. S30 represents an arbitration of the wheel data and the vehicle body data, in particular with the aid of the first computing unit 3; in particular additionally an operation of an actuator of the chassis control based on the arbitration. In one embodiment, the method can be or is repeated, in particular as long as or while the chassis control is operated.

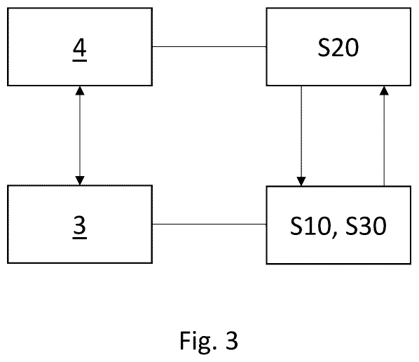

FIG. 3 schematically shows a first computing unit 3 and a second computing unit 4, which are connected for data exchange (see arrows between the computing units 3, 4). Actual signals, in particular wheel data, and desired signals, in particular with regard to the dynamics of the vehicle body (vehicle body data), are exchanged in one embodiment between the first computing unit 3 and the second computing unit 4. In one embodiment, the first computing unit 3 is configured to convert the desired signals and the second computing unit 4 is configured to calculate or determine desired signals, in particular with regard to vehicle body dynamics. Furthermore, it is shown that, in one embodiment, the first computing unit (3) is configured to implement method steps S10 and S30 and the second computing unit (4) is configured to implement method step S20.

While at least one exemplary embodiment has been described above, it is to be noted that a large number of variations thereto exist. It is also to be noted that the exemplary embodiments described are only non-limiting examples, and it is not intended that the scope, applicability, or configuration of the devices and methods described herein are thus restricted. Rather, the preceding description will provide the person skilled in the art with an introduction to the implementation of at least one exemplary embodiment, wherein it is understood that various modifications can be performed in the functionality and the arrangement of the elements described in an exemplary embodiment, without deviating from the subject matter defined in the appended claims and its legal equivalents.

1. A chassis control of a chassis, comprising a first computing unit and a second computing unit arranged spaced apart from one another, wherein the first computing unit is configured to determine wheel data describing wheel dynamics of a wheel; and wherein the second computing unit is configured to determine vehicle body data describing the body dynamics of a vehicle body, wherein the first computing unit and the second computing unit are connected for data exchange; wherein the first computing unit is configured to arbitrate the wheel data and the vehicle body data, and wherein the chassis control is configured to determine a desired force for an actuator of the chassis control.

2. The chassis control according to claim 1, wherein the first computing unit is configured to determine the wheel dynamics with a cycle time in the range of the natural frequency of the wheel.

3. The chassis control according to claim 2, wherein the second computing unit is configured to determine the vehicle body dynamics with a cycle time in the range of the natural frequency of the vehicle body.

4. The chassis control according to claim 1, wherein the cycle time of the first computing unit is 1 ms or less.

5. The chassis control according to claim 1, wherein the cycle time of the second computing unit is greater than 4.5 ms.

6. A method for operating a chassis control according to claim 1, comprising:
capturing wheel data using the first computing unit;
determining an actuator response of the chassis based on the captured wheel data;
capturing vehicle body data using the second computing unit;
determining an actuator response of the chassis based on the captured vehicle body data;
arbitrating the wheel data and the vehicle body data with the aid of the first computing unit; and
operating an actuator of the chassis control based on the arbitration.

7. A vehicle comprising a chassis control according to claim 1.

8. The chassis control according to claim 2, wherein the cycle time of the first computing unit is 1 ms or less.

9. The chassis control according to claim 3, wherein the cycle time of the first computing unit is 1 ms or less.

10. The chassis control according to claim 2, wherein the cycle time of the second computing unit is greater than 4.5 ms.

11. The chassis control according to claim 3, wherein the cycle time of the second computing unit is greater than 4.5 ms.

12. The chassis control according to claim 4, wherein the cycle time of the second computing unit is greater than 4.5 ms.
